(19) United States
(12) Patent Application Publication
(10) Pub. No.: US 2006/0193641 A1
(43) Pub. Date: Aug. 31, 2006

(54) Light modifier with spiral optical forms

(76) Inventor: Michael Callahan, New York, NY (US)

Correspondence Address: DAVIDSON, DAVIDSON & KAPPEL, LLC, 485 SEVENTH AVENUE, 14TH FLOOR, NEW YORK, NY, 10018, US

(21) Appl. No.: 11/350,976

(22) Filed: Feb. 9, 2006

Related U.S. Application Data
(60) Provisional application No. 60/651,240, filed on Feb. 9, 2005.

(51) Int. Cl. G03G 15/04; G03G 15/22; G03G 15/00

(52) U.S. Cl. 399/6

(57) ABSTRACT

Improved methods and apparatus for varying one or more parameters of a light beam are disclosed. In some embodiments, one or more light modifying elements are interposed in the light beam between the light source and a subject illuminated, each of said light modifying elements having a pattern of both areas of light modifying material and other areas without such material. An additional element produces a complementary light pattern, such that relative displacement of said additional elements and said at least one light modifying element can vary the proportion of light from said light source that passes through said light modifying material and reaches said subject. One or more of said additional elements may be provided and may increase the efficiency of the disclosed apparatus and/or provide additional functions.

This application claims priority to U.S. Provisional Application Serial No. 60/651,240, the entire disclosure of which is hereby incorporated by reference.

### FIELD OF THE INVENTION

This application relates to lighting, and more specifically, to improvements to lighting fixtures and accessories.

### BACKGROUND OF THE INVENTION

It is an object of the instant application to disclose apparatus and methods for changing the apparent color (and/or other parameters) of the light exiting a fixture, that answers long-felt needs, and does so without the various disadvantages of the many mechanisms previously disclosed.

### SUMMARY OF THE INVENTION

The instant application relates to an improved apparatus and method for varying one or more parameter of the light exiting a fixture.

The apparatus and method of the present invention employs the output of a light source that, at least in the region of one or more “light-modifying elements”, is in a spiral form.

The pitch and width of this spiral luminous form, is, at least in this region, such that a complementary area and pattern are formed, such that a similar pattern of light-modifying material (such as, but not limited to, a color filter material) on one or more such “light-modifying elements” and will, in one orientation, fall within this complementary area (thus, having little or no effect), and, in another orientation, will substantially completely intersect (and effect) the light in the spiral form.

Many techniques are possible for creating this spiral luminous form, including appropriate designs of a light-collecting reflector and/or of a “first optical element”.

“Light-modifying elements” performing many functions are possible.

Further, at least one additional optical element can be provided subsequent to the “light-modifying element(s)”, for purposes including additional modifications to beam parameters and/or reversing the effect of a prior optical element(s).

The disclosed system can cooperate in the optical design of a fixture as a whole, or it can be made optically neutral, such that the disclosed system can be employed internal or external to existing fixtures without a significant impact on their beam characteristics other than as specifically desired.

Apparatus and methods will also be disclosed for generally tubular light sources as well as other embodiments and systems.

### BRIEF DESCRIPTION OF THE DRAWINGS

FIG. 1 is a section, parallel to the optical path, illustrating a parameter-modifying system of the present invention.

FIG. 2 is an elevation, perpendicular to the optical path, illustrating one embodiment of a “light-modifying element”

FIG. 3 is an elevation, perpendicular to the optical path, of a mask in spiral form.

FIG. 4 is an elevation, perpendicular to the optical path, illustrating luminous energy distributed in one spiral form as it falls upon a light-modifying element.

FIG. 5A, is an elevation, perpendicular to the optical path, illustrating one embodiment of a “light-modifying element” and a mask, as illustrated in the prior Figures, with the two aligned relative to each other to produce no effect of the light-modifying material.

FIG. 5B, is an elevation, perpendicular to the optical path, illustrating one embodiment of a “light-modifying element” and a mask, as illustrated in the prior Figures, with the two rotated 45 degrees relative to each other to produce a 25% effect of the light-modifying material.

FIG. 5C, is an elevation, perpendicular to the optical path, illustrating one embodiment of a “light-modifying element” and a mask, as illustrated in the prior Figures, with the two rotated 90 degrees relative to each other to produce a 50% effect of the light-modifying material .

FIG. 5D, is an elevation, perpendicular to the optical path, illustrating one embodiment of a “light-modifying element” and a mask, as illustrated in the prior Figures, with the two rotated 180 degrees relative to each other to produce a complete effect of the light-modifying material

FIG. 6 is a section, parallel to the optical path, illustrating one form of a light-collector/reflector producing a spiral form.

FIG. 7A is a section, parallel to the optical path, illustrating one “recapture” technique.

FIG. 7B is a detail section, parallel to the optical path, illustrating another “recapture” technique.

FIG. 8 is a section, parallel to the optical path, employing a spiral prismatic lens.

FIG. 9 is a section, parallel to the optical path, illustrating a second optical element, here a spiral prismatic lens, subsequent to at least one light-modifying element.

FIG. 10A is an isometric view, with a wedge-shaped portion removed from each, of the first and second optical elements of the prior Figure.

FIG. 10B is a detailed section of the prismatic seen in prior Figures.

FIG. 10C is an exploded isometric view of one embodiment of a system as illustrated in the prior Figures.

FIG. 11A is a simplified section of a “leko”-type fixture with one of the disclosed systems attached at the fixture's beam exit.

FIG. 11B is a simplified section of a “leko”-type fixture with one of the disclosed systems installed between the fixture's source and gate.

FIG. 11C is a simplified section of a “leko”-type fixture with one of the disclosed systems installed in the fixture's lens barrel.

FIG. 11D is a simplified section of a “leko”-type fixture with one of the disclosed systems installed after the fixture's gate.

FIG. 12 is an elevation of a light-modifying element with a dual spiral pattern.

FIG. 13 is an elevation of a light-modifying element with a quad spiral pattern.

FIG. 14A, is an elevation, perpendicular to the optical path, illustrating one embodiment of a system employing the quad spiral pattern of the prior Figure, with the “light-modifying element” aligned to produce no effect.

FIG. 14B, is an elevation, perpendicular to the optical path, illustrating one embodiment of a system employing the quad spiral pattern of the prior Figure, with the “light-modifying element” rotated 15 degrees relative to the luminous spiral form to produce a 33% effect of the light-modifying material.

FIG. 14C, is an elevation, perpendicular to the optical path, illustrating one embodiment of a system employing the quad spiral pattern of the prior Figures, with the “light-modifying element” rotated 30 degrees relative to the luminous spiral form to produce a 66% effect of the light-modifying material.

FIG. 14D, is an elevation, perpendicular to the optical path, illustrating one embodiment of a system employing the quad spiral pattern of the prior Figure, with the “light-modifying element” rotated 45 degrees relative to the luminous spiral form to produce a complete effect of the light-modifying material.

FIG. 15A is an elevation, perpendicular to the optical path, illustrating a continuous spiral pattern and complement having a parameterized radial increment.

FIG. 15B is an elevation, perpendicular to the optical path, illustrating a continuous spiral pattern and complement integrating distal region having a constant and aproximal region having parameterized radial increment.

FIG. 15C is an elevation, perpendicular to the optical path, illustrating a continuous spiral pattern and complement integrating two regions having a constant radial increment at a circular boundary.

FIG. 16 is an isometric view of a plurality of light-modifying elements each with spiral patterns that overlap to occlude a luminous form that is, at the point of insertion, wider than any one such pattern.

FIG. 17A is an elevation of a light-modifying element with a pattern differing in effect across its width.

FIG. 17B is an elevation of a light-modifying element with a pattern differing in effect across its width, inverted relative to that of the prior Figure.

FIG. 18 is an isometric view of a plurality of light-modifying elements, supported by and driven from their rims by actuators.

FIG. 19 is an isometric view of a plurality of light-modifying elements, driven about a center post from their rims by actuators.

FIG. 20 is an isometric view of one mechanism for driving two light-modifying elements in opposite directions with a common actuator.

FIG. 21 is a general isometric view of one light-modifying element in generally helical form, wrapped around a generally tubular light source.

FIG. 22 is a general isometric view of a mask in helical form using one “recapture” strategy to increase efficiency.

FIG. 23A is an elevation, perpendicular to the optical path, illustrating one embodiment of another system employing concentric rings with alternating application of light-modifying material in 20 degree segments.

FIG. 23B is an elevation, perpendicular to the optical path, illustrating one embodiment of such another system employing concentric rings with alternating application of light-modifying material, wherein the light-modifying element is rotated 10 degrees, resulting in partial effect.

FIG. 23C is an elevation, perpendicular to the optical path, illustrating one embodiment of such another system employing concentric rings with alternating application of light-modifying material, wherein the light-modifying element is rotated 20 degrees, resulting in full occlusion.

FIG. 24A is an elevation, perpendicular to the optical path, illustrating one embodiment of such another system, employing concentric rings with alternating application of light-modifying material, where the alternating concentric ring pattern period is a function of radial distance, such that the area of each segment is equal.

FIG. 24B is an elevation, perpendicular to the optical path, illustrating one embodiment of such another system employing concentric rings with alternating application of light-modifying material, where the alternating concentric ring pattern period is a function of radial distance, such that the area of each segment is equal to the radiant intensity.

FIG. 24C is an elevation, perpendicular to the optical path, illustrating one embodiment of such another system employing concentric rings with alternating application of light-modifying material as described in FIG. 24B, where the light-modifying element is rotated 10 degrees relative to the mask 20.

### DETAILED DESCRIPTION

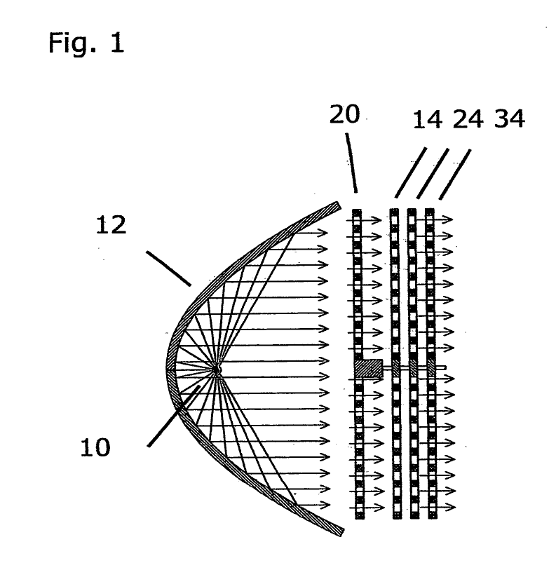

Refer now to FIG. 1, a section, parallel to the optical centerline, illustrating principles of the improved parameter-modifying apparatus and method of the present invention.

A light source 10 and a light-collector 12 are illustrated. They may be mechanically integral or separate. For purposes of this illustration, the collector 12 is of generally parabolic shape and produces generally parallel rays (although, as will be seen, the present invention is not limited to such embodiments).

Light generated by source 10 falls upon at least one “light-modifying element” 14, here shown in a generally planar form.

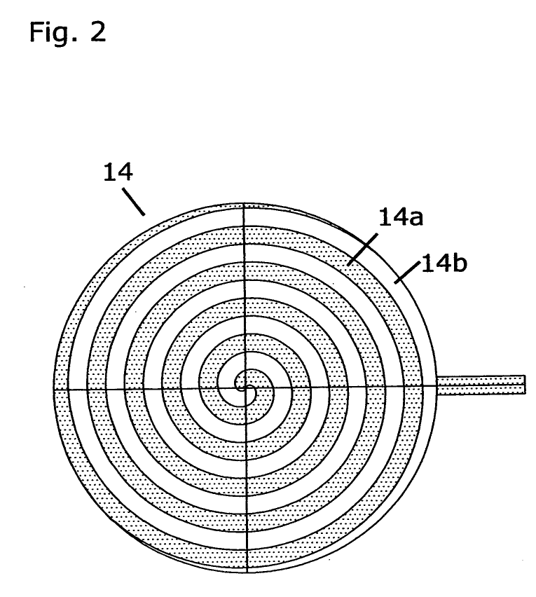

Referring to FIG. 2, light-modifying material 14a is selectively applied to or formed in or on a substrate 14b (or is more generally applied and then selectively removed), so as to produce a pattern. Light rays passing through the portion of the pattern with such material are modified; rays passing through those portions without such material are not. A plurality of such lightmodifying elements can be employed (e.g., elements 14, 24, and 34 as illustrated in FIG. 1). The light-modifying material employed can produce a desired color and/or a color primary; attenuate intensity; and/or diffuse or otherwise modify one or more parameter of the light passing through it.

It will be understood that, absent other elements or features, and with a substantially equal distribution of light across the surface of element 14, that the combination of a source 10, collector 12, and light-modifying element 14 will generally do no more than produce an effect that is proportional to the relative areas of open versus light-modifying material in the pattern if the latter is not imaged by any subsequent optics—and a “gobo” pattern to the extent that it is.

FIG. 1, however, illustrates an additional element 20, between light source 10 and light-modifying element 14.

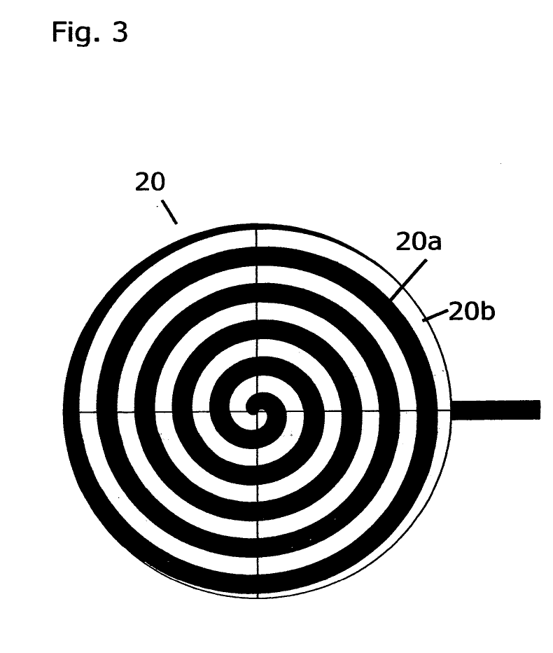

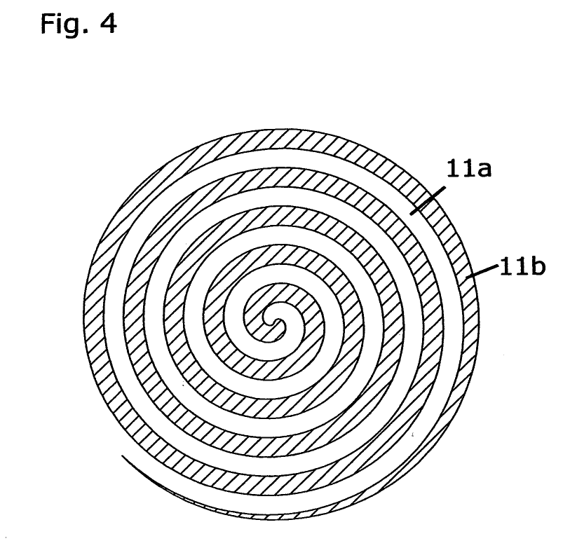

FIG. 3 illustrates one of many possible such additional elements, which, in this example, is a mask of substantially opaque material 20a, in a pattern generally similar to that of light-modifying element 14. This mask produces a complementary pattern of luminous energy 11b, as is illustrated in FIG. 4.

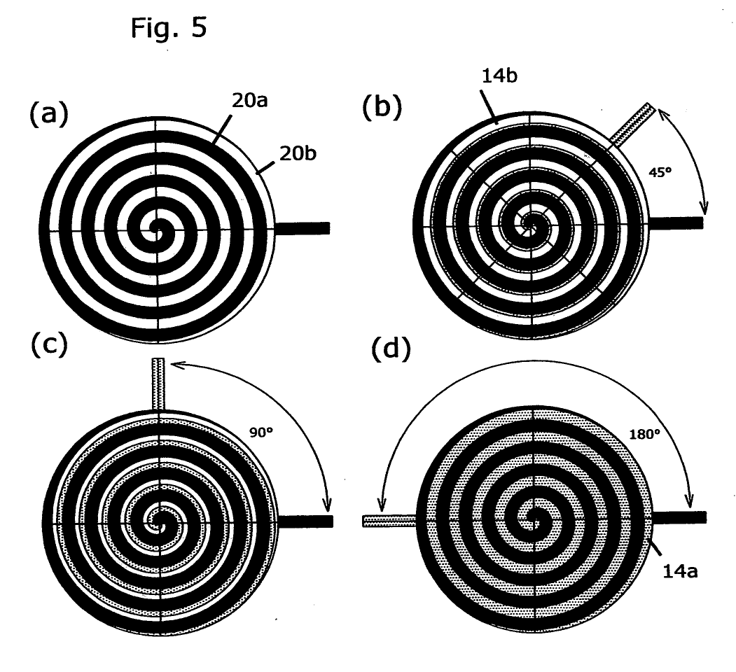

With the two elements 20 and 14 coaxial, and their patterns aligned, (e.g., as is illustrated in FIG. 5A) light rays from source 10 that pass through the transparent areas 20b of element 20, will also pass through the transparent areas 14b of the light-modifying element 14 (as well as any additional light-modifying elements whose patterns are similarly aligned). The light-modifying material 14a of element 14 will, therefore, have no effect.

However, relative displacement of these two elements, including by their rotation about a central axis common with that of mask 20, will result in the progressive insertion of the light-modifying material of the light-modifying element(s) into the luminous energy 11b, and, therefore, as is illustrated in FIGS. 5B-5D, in progressively increasing effect, until (as is illustrated in FIG. 5D) complete alignment of the light-modifying material with the luminous energy 11b, such that substantially all rays of light exiting the assembly have encountered the light-modifying material.

Displacement, in this example by rotation of a light-modifying element relative to luminous energy in a similar form, can thus provide for the adjustment of one or more parameter.

A plurality of light-modifying elements 14, 24, and 34, can be provided for, for example, color, color primary, intensity, diffusion, and/or other modification. (Light-modifying elements can also include optical components, elements, and/or features that perform or assist in performing modification to, for example, beam size, shape, and/or that introduce desired effects.)

It will be apparent that, in the case of the use of a simple mask(s) that such mask(s) can precede; follow; and/or be located between light-modifying and other element(s).

The combination of mask and light-modifying elements can be produced with great economy, in versions printed on; fabricated of; or applied to rigid or flexible sheet and film, including for non-lighting applications.

It will be apparent that, in the case of the use of a simple mask and of uniform light distribution across it, light losses will be significant.

Therefore, preferably, the distribution of luminous energy into a desired form will be made more efficient.

One approach is to employ a light collector whose geometry is adapted to asymmetrically distribute luminous energy in the desired form at the light-modifying element(s). Suitable light-collectors (with or without the use of additional elements, including for control of direct versus reflected rays from the light source, masks, and/or additional optics) can be produced with techniques including reflective plural concave patterns; reflective holographic elements; micro-optical mirrors; prisms; random refractive micro-optical elements; or others. Such light-collectors can employ continuous evolutions of the desired form or can employ a series of “facets”, each having a desired shape, and, in either event, can be formed into a general shape that is a parabaloid, an ellipse, or any other desired form.

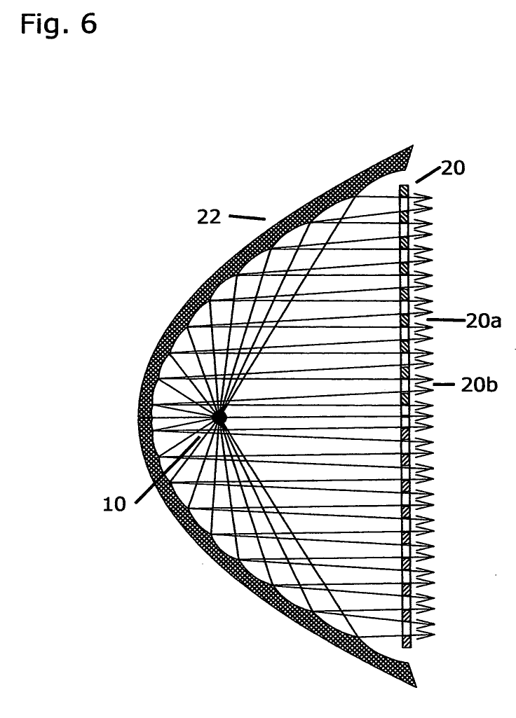

FIG. 6 is a section through one such light-collector 22 illustrating the “grooves” of a light-collector/reflector having a spiral form, and its direction of the output of source 10 through the “open” portions 20b of mask 20.

A “recapture” approach can be employed.

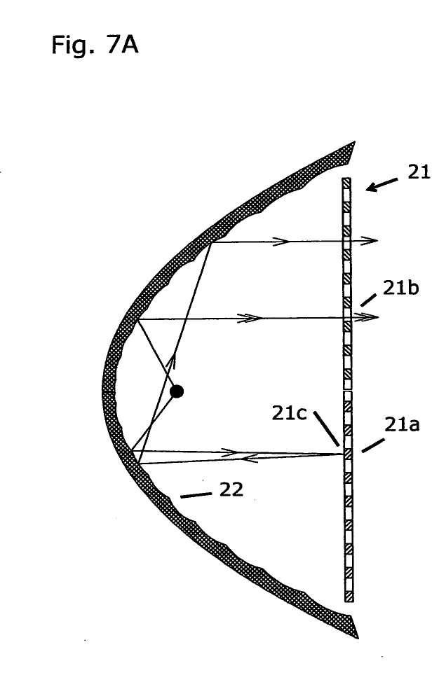

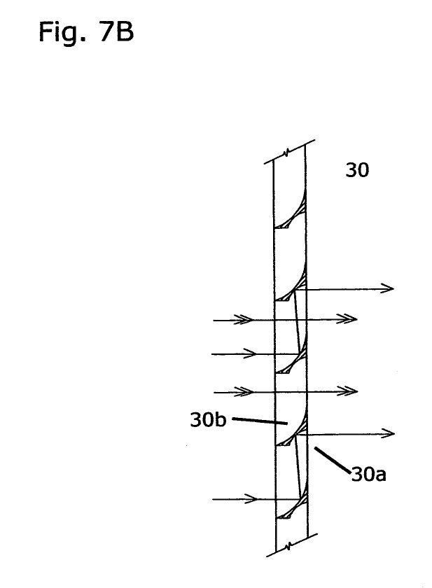

FIG. 7A is a section through a system in which a reflective surface 21c is present on the source-ward side of the non-transmissive portion 21a of the pattern of mask 21. Rays falling upon this portion, that would otherwise be lost, are redirected back to reflector 32 for re-use.

FIG. 7B is a detailed section of an element 30, disposed prior to the first light-modifying element, that incorporates generally transparent portions 30b, through which rays can pass to produce the desired luminous form. Such an element (or elements) also include(s) surfaces 30a designed to efficiently capture and redirect light that would otherwise be wasted. “Vanes” 30c-30g incorporate reflective surfaces shaped to “fold” light falling upon those portions of the element that do not allow direct transmission into regions that do. In embodiments in which features like the illustrated “vanes” are essentially opaque to direct transmission of light, it will be recognized that they can serve a “masking” function.

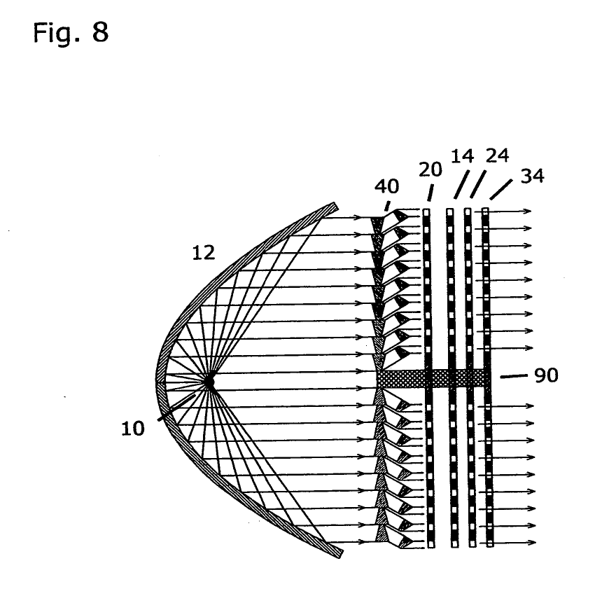

An optical element can be used to capture virtually all of the light energy falling on its source-side and concentrate it into the desired form. FIG. 8 is a section through one possible system that employs an element 40, here a spiral pattern prismatic optic, condensing light incident upon it into the desired spiral form. Many suitable techniques may be employed including, but not limited to, lenses, microlenses, anamorphic prisms, GRIN lenses, TIR prismatics, and tapered fiber optics.

Recapture or concentrator element(s) can be formed of one or more separate layers, sections, and/or components. An element can be fabricated as a single unit or can be assembled from multiple layers or components. Diffusion can be included, as can various forms of geometric, chromatic, and other modification or correction.

Some prior disclosures of interest include U.S. Pat. Nos. 2,510,344 to Law; 4,350,412 to Steenblik; and 4,456,344 to Bordignon.

Any, or any combination, of the described approaches can be used to concentrate the luminous energy produced by the light source into the distribution desired for improved efficiency through the light-modifying element(s) employed.

Additional functions such as blocking or reflecting undesired wavelengths (e.g., with a “hot mirror” coating) can be performed.

Among the many advantages of the apparatus and method of the present invention is the versatility of its application.

Prior Figures have employed, for purposes of illustration, essentially parallel rays passing through one or more light-modifying elements.

However, the method and apparatus of the present invention are not limited to such applications.

In other applications, the paths of light rays may diverge as they pass through a region with one or more light-modifying elements. The pattern/distribution of light-modifying material on one or more element can be adjusted (in simple terms by varying the “scale factor” of the pattern) to compensate for the divergent ray paths.

In other applications, the paths of light rays may converge as they pass through a region with one or more light-modifying elements. The pattern/distribution of light-modifying material on one or more element can also be adjusted (again, in simple terms by varying the “scale factor” of the pattern) to compensate for the convergent ray paths.

This adaptability is one of many advantages of the apparatus and method of the present invention, as it permits the insertion of an embodiment at many locations, in many different optical systems.

The use of a first optical element prior to the light-modifying element(s) permits many forms of optical manipulation. Rays falling upon the first optical element (or a combination of elements) may be altered in direction, distribution, or otherwise.

For example, while producing or preserving a common general direction, bundles of rays passing through a given “band” in the luminous form can be made (or made more) parallel or convergent in the region of the light-modifying elements.

While the prior Figures illustrate light-modifying elements with regular patterns of a uniform light-modifying material, it will be understood that the type, hue, saturation, and/or pattern of light-modifying material can be varied, as needed or desired, for many purposes, including to compensate for variations in the location, width, shape, and/or intensity of the luminous form where they intersect, and/or to produce deliberate variations for purposes including, but not limited to, aesthetic effect.

It will also be understood that many applications can employ light-modifying elements that are sufficiently inexpensive as to be disposable—for example, specific “gel” colors can be printed, applied, or trimmed and then bonded or laminated to/in a substrate, such that a user can order specific colors and exchange them in a system.

While filters or coatings can be used as the light-modifying material, it will be understood that light-modifying materials, forms, and/or elements having optical effect(s) can be employed.

The relative rotation of at least one element of the system enables the use of polarization materials, elements, and effects.

In many applications, the light exiting from the last light-modifying element will be suitable for use.

In others, a fixed or variable level of diffusion or randomization may be employed., One or more optical elements can be employed, subsequent to at least one of the light-modifying elements, for various purposes (in one example, a (or an interchangeable assortment of) beam-angle-modifying spread lens(es)).

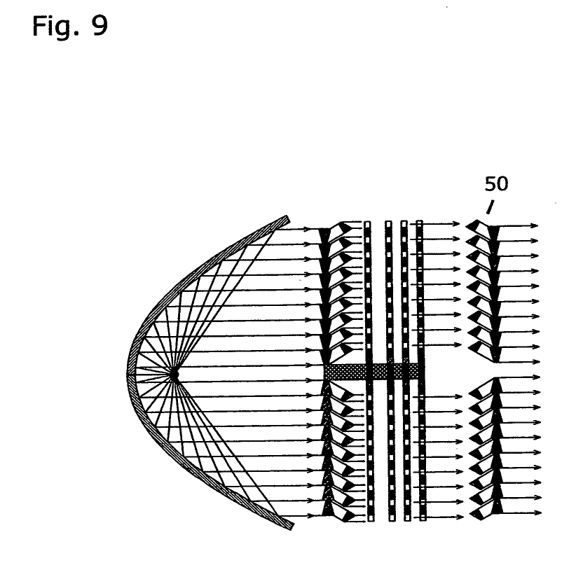

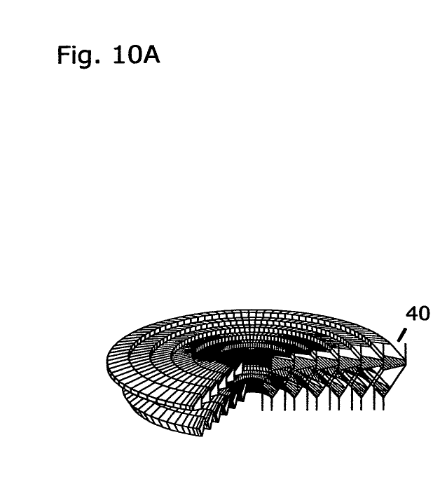

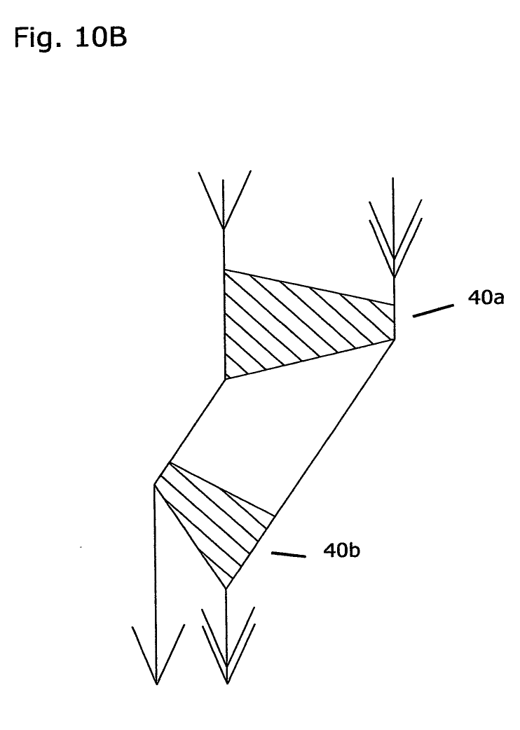

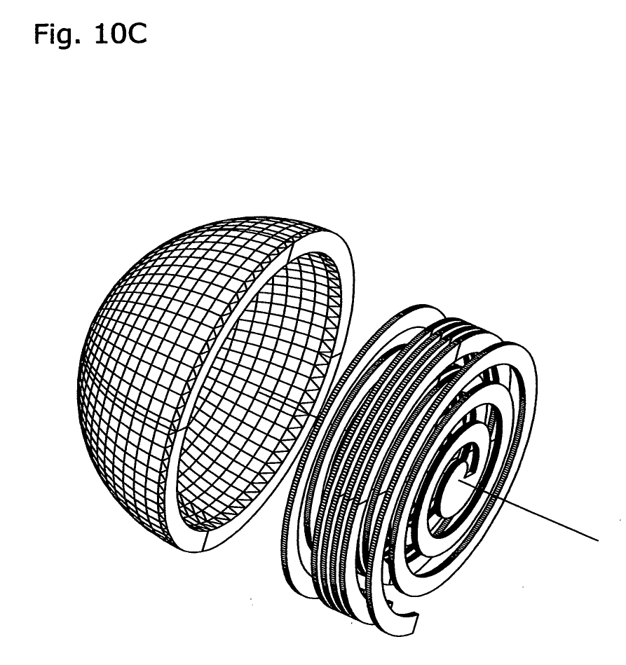

FIGS. 9 and 10A illustrate at least one additional optical element, subsequent to the light-modifying elements, employed in further modifying beam characteristics. Subsequent optical element 50 is here illustrated as another prismatic lens.

FIG. 10B is a detailed section showing a dual element, anamorphic prism assembly. This well-known prismatic construction produces an achromatic reduction in beam width in one dimension (in the plane of the sheet). While the fine structure of the present invention permits diffusive paraxial color mixing, thus minimizing the chromatic effects of oblique paraxial rays, the reproducibility of the spectral distribution is enhanced by the incorporation of the achromatic optics.

Subsequent optical element 50 may be designed for an effect complementary to that of the first optical element 40, such that the combination (beyond assuring the desired luminous distribution for the light-modifying elements between them) is neutral, and insertion of the system in or external to the optics of a fixture need have no effect(s) other than those intended.

Such subsequent optical element(s) can be designed (and/or can cooperate with other elements) to introduce desired modifications and/or variations in one or more parameter of the light exiting the system.

For example, one or more subsequent optical element can assist in determining the size, shape, edge, and/or intensity distribution of the beam.

The effect of such a subsequent optical element can be fixed or variable.

For example, where one or more such optical elements form a beam having an asymmetrical shape, rotation and/or other displacement of one or more such element can be used to rotate and/or to re-form the beam.

Optical element(s) can include a variation in optical effect across a spiral pattern, such that rotation of that/those element(s) relative to each other and/or to the first element will change beam size, shape, and/or other parameter. Optical element(s) can be designed to be asymmetrical in effect across their surface at some or all points of their relative displacement such that, for example, a variation in beamspread is produced, in whole or in part, by differences in effect between inner and outer regions.

Further, it will be recognized that the light source, light collector, light-modifying element(s), and any elements between source and light-modifying elements used to improve system efficiency can be substantially similar in many applications for different fixture types; differing substantially only in the optical element(s) subsequent to the light-modifying elements. Therefore, a common assembly can be used for the recited elements and alternate modules used to change the character/performance/features of the fixture as a whole.

Possible techniques for fabrication of subsequent optical elements for varying beam parameters include but are not limited to fresnel, GRIN, HOE, microlens, microprismatic and microdiffractive optics.

FIG. 10C is a generalized exploded isometric of the elements of the prior Figures as used in one simple system.

In any form or application, the light-modifying system of the present invention has many advantages.

It is unusually compact, simple, and therefore reliable, and is applicable, in its variations, to a wide variety of fixture types.

The capability to perform modifications to not just beam color and intensity, but to beam size/amgle and shape, offer added benefits.

For example, one known fixture type is the “fresnel” fixture, which remains widely employed in film and television lighting because of its relatively flat field, soft edges, and variable beam size. The traditional such fixture, however, is grossly inefficient as only a limited portion of source output is captured by either the lens or reflector; most is lost within the housing. Further, beam angle is reduced by mechanically displacing the source and reflector away from the fresnel lens, leading to additional losses. In most film and television applications, adjustment of fixture intensity must be performed by inserting metal screens (or “scrims”) in front of the lens, either because the source is halogen and conventional control of intensity by varying average power supplied to the lamp would result in undesirable shifts in color temperature—or because the source is gas discharge and cannot be dimmed over a wide range and/or without undesirable color shifts.

The disclosed system has the benefit of permitting changes in beam intensity, color, and diffusion with an exceptionally compact, rugged, reliable, and economical mechanism. Further, the system's optical elements can perform the function of, and produce a beam with the same qualities as, a fresnel. Beam size can be adjusted by the system, while permitting the use of a substantially more efficient light/collector reflector than traditional fresnel fixtures; dramatically increasing the light output from a fixture of a given size and power demand.

In no fixture or application need the disclosed system require a filter area significantly larger than the beam—with all the advantages that attend, especially in those fixtures without an internal focal point, as well as in those that do.

Because the system is so compact and simple in both design and operation, it will be apparent that the incremental costs of each additional light-modifying element are modest, and that a relatively large number of such elements can be used—a number substantially greater than prior color-changing and color-mixing systems would permit in most applications. A color-mixing system, for example, might divide the visible wavelengths into a number of bands whose relative proportion could be selectively attenuated by different light-modifying elements (an approach comparable to “parametric” equalization in audio). A CYM system might be supplemented with additional elements for extending the range of colors produced. A color-changer that employs a number of light-modifying elements each fabricated with a specific “gel” color is possible—instead of, or in addition to, a set of color-mixing elements. (As will be seen, field exchange and replacement of light-modifying elements can be very simple.)

Because the light-modifying effect can be evenly distributed across the beam, the system's location in the optical path in many fixture types is less critical, in regards its imaging, and, therefore, an uneven effect across the beam at the subject.

It will be seen that the scale of the pattern of the light-modifying material on the light-modifying elements can be varied to achieve economy of fabrication and reasonable tolerances for each application.

In optical systems that might image the pattern, pattern size and/or the optical elements prior and/or subsequent to them can be adapted suppress such effects, and/or diffusion or randomization employed for the purpose.

It has been one disadvantage of prior art mechanisms that inserting relatively compact filters into the beam results in a relatively abrupt effect and in limited resolution, unless high-resolution filter drives are employed.

The spiral form of the system of the present invention has the advantage that, for example, a single spiral elongates the range of displacement between no and full effect to 180 degrees of rotation, without increasing the size of the filter or mechanism, permitting a very high degree of resolution from relatively low-precision components of modest cost.

In one other application, a system can be used to provide calibrated color reference, whether for transmitted or reflected light. The components of such a unit would be simple and economical, and the 180 degree range of adjustment provides a high degree of precision.

Another advantage of the disclosed apparatus and method relates to applications in which an image is passed.

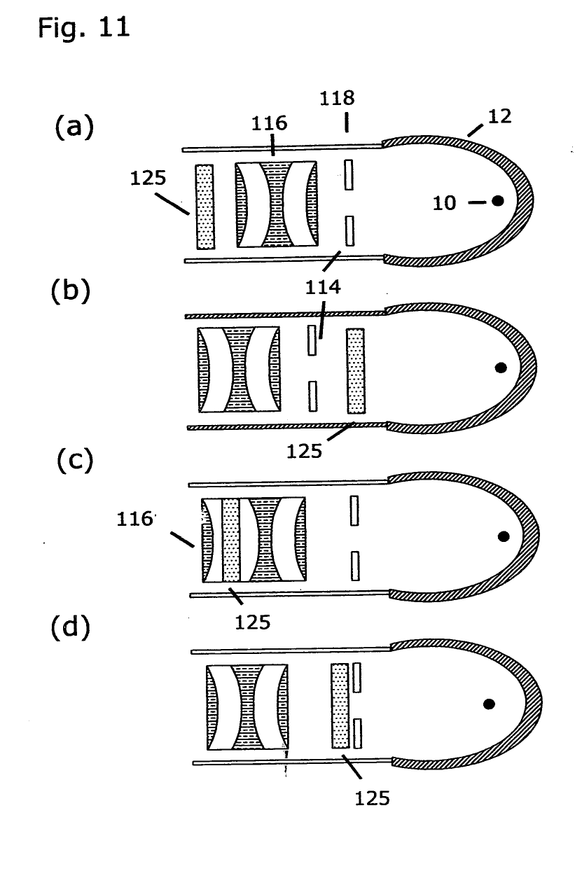

FIGS. 11A-11D illustrate several applications in one such common fixture type—here a traditional “leko” fixture.

Such fixtures employ a generally ellipsoidial reflector 112 with a light source 110 at its first focus and its second focus falling generally beyond a “gate” or aperture 114. One or more lenses are used to image gate 114 in order to impart a similar shape to the beam exiting the fixture. Such lens(es) are typically mounted (for example, in a “lens barrel” 116) so as to be moveable along the elongated beam axis in order to shift focus, to compensate for different fixture-to-subject distances and/or “soften” edge sharpness for aesthetic purposes. Some fixtures incorporate multiple lenses that can be independently displaced to vary beam angle/focal length, as well as focus. Such fixtures also typically incorporate various provisions, including known shutters, irises, and “gobos”, installed or inserted at or near the gate, to vary beam shape.

In the case of such fixtures, a parameter-modifying system 125, such as illustrated in prior Figures, could be installed in the fixture between the source 110 and gate 114, where it would have many advantages, relative to prior methods.

Installation of a parameter-modifying mechanism forward of gate 114 may be desirable for various reasons, but, insofar as the fixture's lens(es) are imaging the gate area, any mechanism employed after the gate must address the issue of undesirable effects on that image.

Prior art mechanisms that condense plural “beamettes” and that employ radial, linear, or matrix filter patterns have been disclosed as employing optical elements that, as described, produce distortions and artifacts that compromise their ability to pass the images found in the optical path of “lekos” and other “projection-type” fixtures. One important cause is that, without improvements to such optical elements that are not disclosed, each edge of each element used in producing a “beamette” also introduces distortion, and the optical systems typically employed in such fixtures are less tolerant of such distortion unless it is substantially radial to the optical center. All of the versions previously disclosed produce virtually all of their distortion in non-radial directions.

It is a characteristic of basic spiral forms that, after the first 180 degrees of the spiral's evolution, a line drawn perpendicular to a tangent to the spiral will fall close to its center. As such, virtually all of the distortion produced by simple optical forms will fall on or close to that direction in which they will have the least impact. Therefore, the system of the present invention can be applied to image-passing applications while using more economical components.

By contrast, the condensing optics disclosed in the prior “plural beamette” mechanisms generate radial and tangential discontinuities that produce undesirable artifacts in a projected beam and image. Complex optics, which reduce the convergence and chromatic aberrations, are required to reduce these errors. Even so, alignment and diffractive errors would still persist.

The method and apparatus of the present invention thus may be employed in image-passing portions of an optical system. Therefore, system 125 can also be employed subsequent to gate 114 (as illustrated in FIG. 11D). It can be incorporated in lens barrel 116 (as illustrated in FIG. 11C), to simplify insertion and removal, as well as “retrofit” to present fixtures. And it can be packaged to attach to the front of the fixtures, typically by means of the fixture's gel frame holder, in a format equivalent to present “scrollers” (as illustrated in FIG. 11A).

The optics associated with system 125 can be “optically neutral” as has been described, or can provide (or cooperate in providing) additional functions. For example, where insertion of system 125 between source 110 and gate 114 may require spacing the two farther apart in an existing fixture design to provide mechanical clearance, the result will be a shift in reflector 112's second focal point. System 125 can correct for such increased spacing, such that it may be employed in this manner in existing fixture designs without undesirable effect or compensation.

Similarly, system 125 may provide or cooperate in functions like changing beam size, shape, or other characteristics.

Additional Figures illustrate some of the many possible variations in the pattern of the luminous form and of the various elements.

A variation in the displacement/rotation required for the complete range of parameter adjustment can be made by one or more of several means.

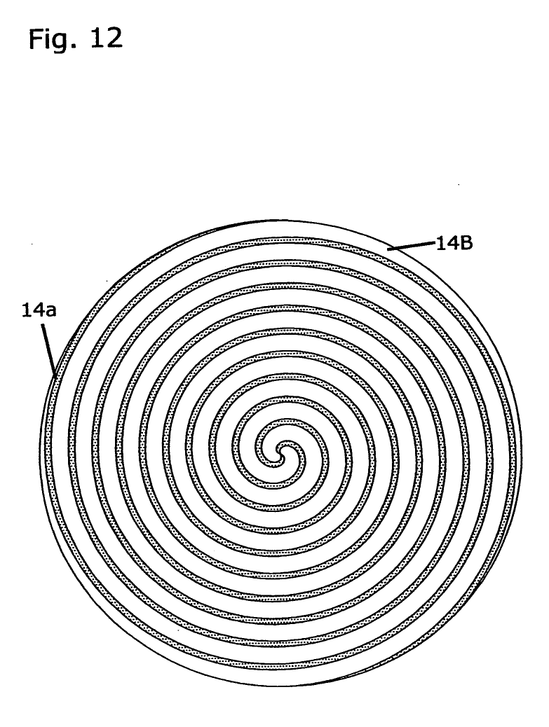

FIG. 12, for example, illustrates a dual spiral pattern that reduces the amount of rotation/displacement required by 50%, relative to a single spiral.

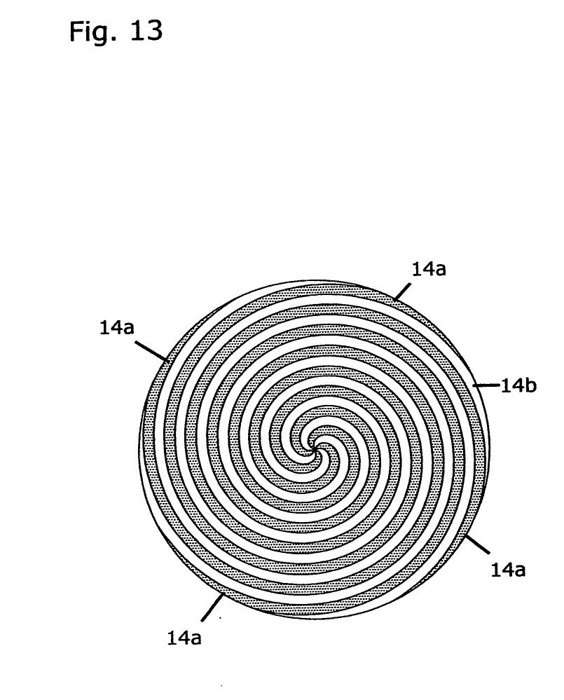

Any number of spirals can be used—FIG. 13 illustrates a “quad” version.

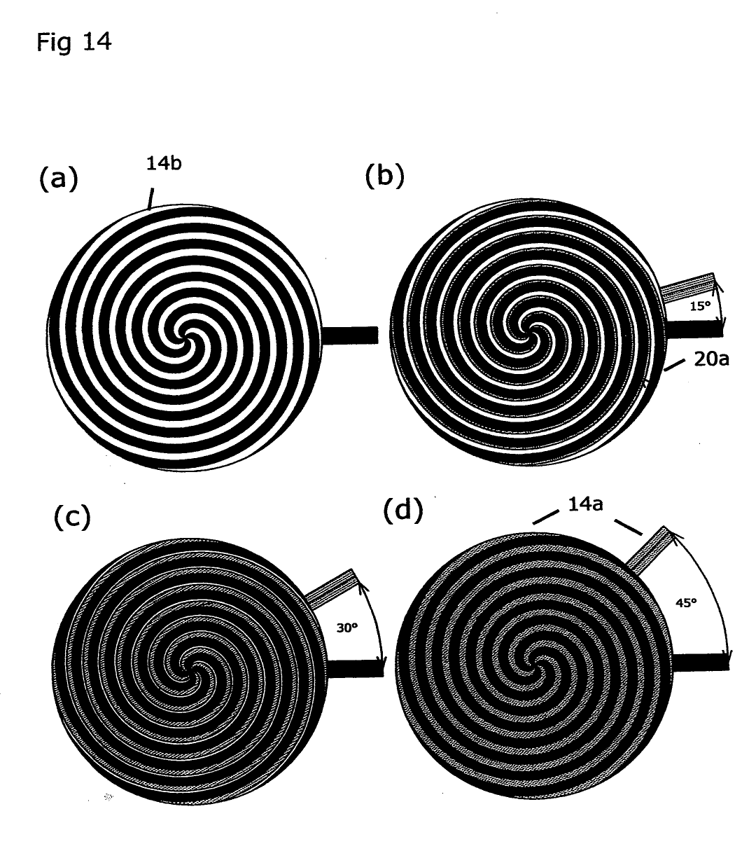

FIGS. 14A-14D illustrate the operation/range of displacement/rotation required by such a “quad” version, which reduces the rotation required by a factor of four.

Further, the rotation required for a full range of adjustment can be reduced by combining rotation with a lateral displacement of the light-modifying material relative to the luminous form (for example, by offsetting its pattern center and its rotational center). Such displacement results in faster insertion of the light-modifying material into the luminous form for a given degree of rotation. Adjustment of the luminous form/pattern ratio and/or of the pattern itself may be desired.

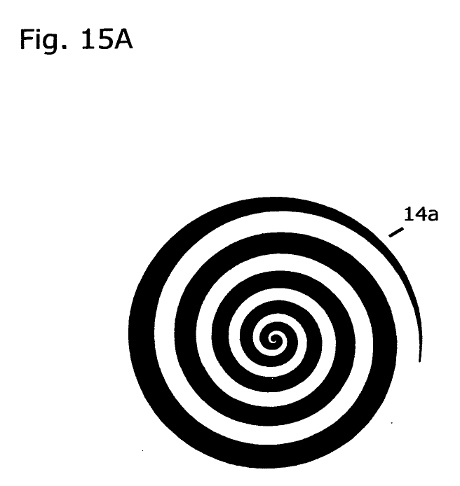

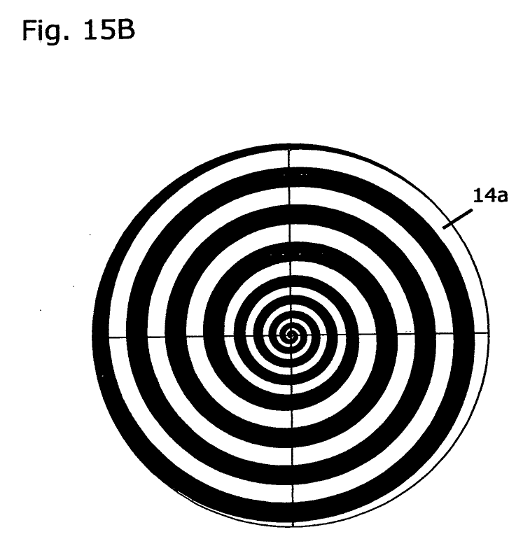

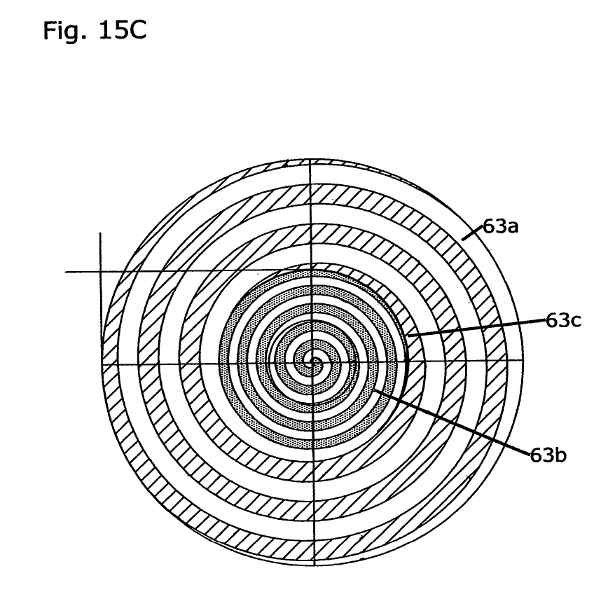

FIG. 15A is an elevation, perpendicular to the optical path, illustrating a continuous spiral pattern and complement having a parameterized radial increment whose form may be described by, but is not limited to, additive, multiplicative, exponential, logarithmic, hyperbolic or complex functions. The specific function may have defined ranges and conform to the luminous intensity of the lamp source, or design optical path. For example, the logarithmic spiral (r=ae^{kφ}) maintains a constant tangential angle between the origin and the curve, simplifying the optical computation and construction of an integrated anamorphic or fresnel lens.

FIG. 15B is an elevation, perpendicular to the optical path, illustrating a continuous spiral pattern and complement integrating distal region having a constant and a proximal region having parameterized radial increment permitting an increase in the number of spiral revolutions having a large tangential angle proximal to the origin.

FIG. 15C is an elevation, perpendicular to the optical path, illustrating a continuous spiral pattern and complement integrating two regions 63a and 63b having a constant radial increment at a circular boundary 63c, thereby permitting a continuous optical construction without radial discontinuities.

Any of the illustrated or other patterns and their variants can employ other improvements.

For example, one or both edges of a pattern of light-modifying material can be shaped to graduate the effect of its intersection/insertion in the luminous form. The effect can be differential across the spiral form (e.g., differ at different radii along the same radial) such that the light-modifying material is progressively inserted and/or it can be modulated locally (for example, by the use of a “sawtooth” edge) to produce a more gradual insertion of the light-modifying material). Patterns may be adjusted to compensate/correct for asymmetries in the luminous form and/or total system performance.

While most prior Figures have illustrated a ratio/relationship between the width and the pitch of the luminous form that produces a complementary area at least similar in width, into which the light-modifying material can be retracted (e.g., areas 11a and 11b in FIG. 4), significantly greater or lesser ratios/relationships can be employed.

For example, by increasing the ratio, the rotation required for a full range of adjustment can be reduced, for a given spiral form, by appropriate adjustment of the relationship between the pattern of light-modifying material and the luminous form. FIG. 12 illustrates a pattern of light-modifying material 61a that is substantially narrower than the “open” portion 61b.

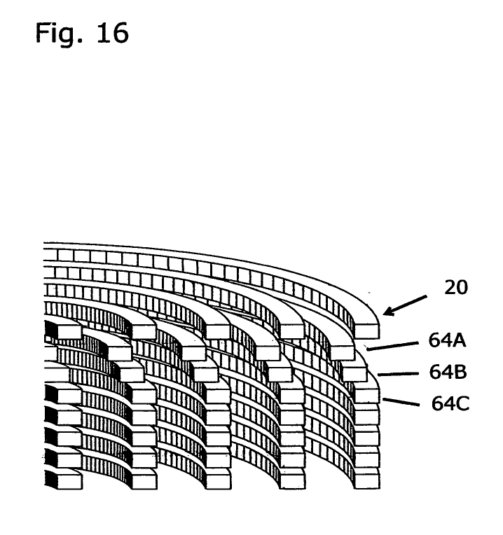

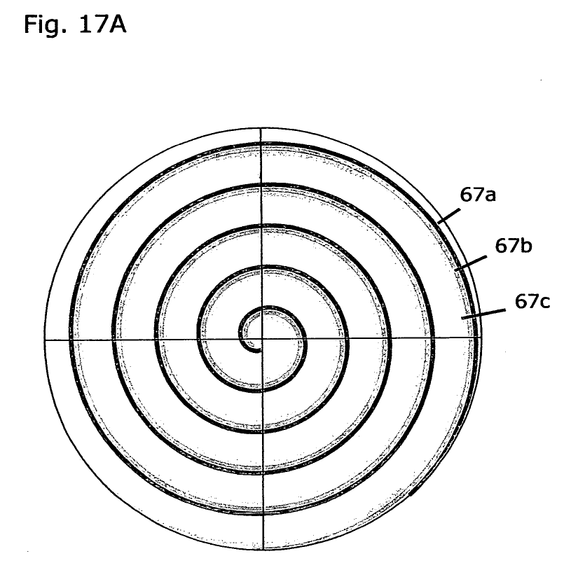

FIG. 16 illustrates how a plurality of light-modifying elements can be employed, each having a pattern of light-modifying material (e.g., 64A, 64B, and 64C) whose width is substantially narrower than that of the luminous form where they intersect. While a single such element would be insufficient to occlude the entire luminous form, a plurality of such elements can be offset or “shingled” to do so. FIG. 16 illustrates such elements partway through one possible sequence of insertion. For purposes of illustration, a mask pattern 20 is shown, whose width is substantially less than the open area they define.

Given a sufficient ratio between the pitch and the width of the luminous form where it intersects a light-modifying element, the width of light-modifying material(s) can be made several multiples of the width of the luminous form, such that a plurality and/or a variety of materials and/or effects can be employed.

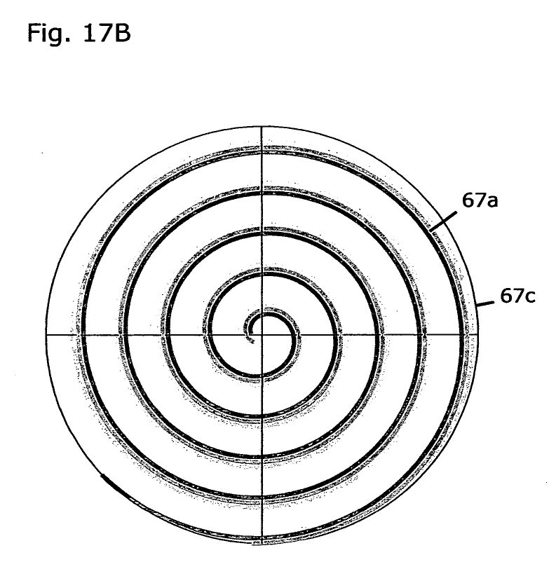

FIGS. 17A and 17B, for example, illustrate a light-modifying element with three parallel spirals 67a, 67b, and 67c, which can illustrate embodiments with bands of different densities of the same material; with a progressive change in the density of one material; with a progressive change in hue or other parameter; or with a plurality of different materials. Multiple colors and/or effects can, therefore, be “multiplexed” on a single element.

It will be seen that rotation of a pattern of light-modifying material in one direction, relative to the luminous form, will insert one edge of that material into the beam, where rotation in the opposite direction will insert the other edge.

This characteristic has several useful applications.

Where a pattern differs across its width (in material, density, effect, and/or edge shape), rotation in different directions allows separate and equal access from either side.

In one example, two parallel spiral patterns allow “duplexing” two materials/effects on a single element, such that either element or “clear” (no effect) can be accessed, each from either of the other two, and without undesirable intermediate effect, by rotation in one or the other direction. In one application, CYM color mixing can be provided with only two light-modifying elements by the use of a double pattern on each, with the recurrence of one of the three-primaries on both elements.

Two separate elements can be rotated in opposite directions to bring (or remove) their materials/effects in or out from opposing sides of the luminous form, for a variety of purposes.

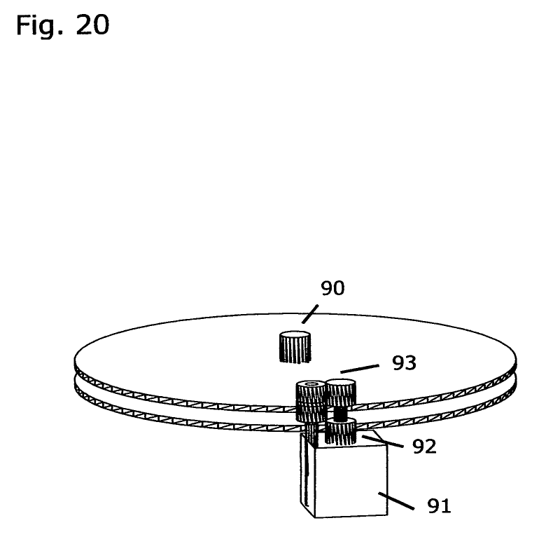

In one such purpose, the same material can be employed on each of the two elements and counter-rotation used to insert and remove it simultaneously from both sides of the luminous form, such that the relative size of the luminous form and of the pattern can be dramatically increased without undesirable consequences in distribution of color/effect at the subject illuminated. FIG. 17B illustrates a light-modifying element 68 with a plurality of parallel spirals in a sequence that is the inverse of element 67 as illustrated in FIG. 17A. FIG. 20 illustrates one possible mechanism for driving two elements in opposite directions with the same actuator.

Systems with their light-modifying patters and luminous forms in offset eccentric relationships can also be used.

Where reference has been made to the use of a “mask”, one, a plurality, or none can be employed in a given application.

While circular beams, optics, and light-modifying elements have been illustrated, it should be understood that other forms, including annular ones, are possible.

Light-modifying elements can be supported and actuated by any suitable means.

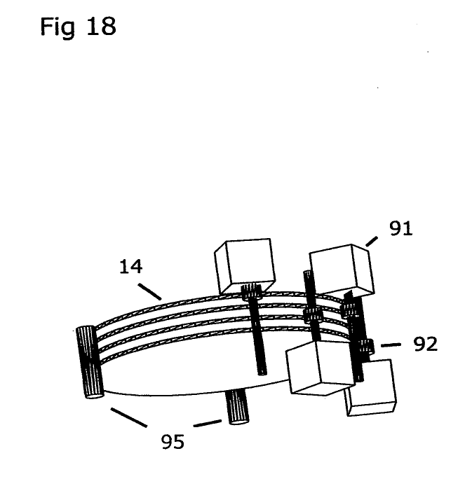

FIG. 18, for example, illustrates a plurality of parallel light-modifying elements 14, 24, 34, and 44 that are both supported and driven from their rims by associated actuators (e.g., actuator 91 and gear 92) and rollers/supports 95.

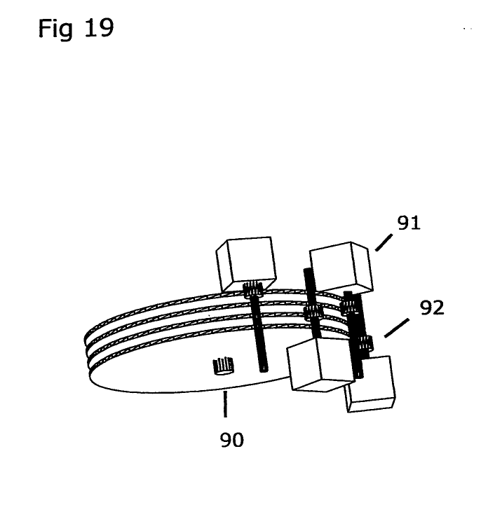

FIG. 19 illustrates a plurality of light-modifying elements 14, 24, 34, and 44 that are driven from their rims by associated actuators around a central shaft or post 90. This technique (also illustrated in some prior Figures) simplifies mechanics and assures proper alignment of the various elements.

Center drive systems are also possible.

And in all such systems, the light-modifying elements can be made readily-replaceable. For example, in center-post embodiments the center-post and its light-modifying elements might be rotated out of the optical path and/or removed for better access/changes.

For purposes of actuation, light-modifying (and other) elements can be formed or fitted with a tab or lever that extends outward to form or connect with a handle exterior to the fixture housing for direct manual adjustment of rotation/effect.

In addition to more conventional powered actuators, elements can be driven by any other suitable means. For example, light-modifying and other elements can be formed or fitted with a material or component that can be driven by a linear motor or piezo actuator. Materials are also known that change length and/or shape, typically when heated. Such materials can be used to rotate/displace the filters, including by the use of a coil of such material in wire form (e.g. Nitinol) that is anchored to the light-modifying or other element on one end and the housing on the other. Changes in length are translated into rotation of the element. Such materials (as well as piezo technology) offer the prospect of actuation with “solid-state” reliability; no noise; minimal power requirements (which could be satisfied by parasitic use of leakage/preheat current from phase control dimmers); and in exceptionally compact packages. One such package would be little larger than present gel frames and exchange with them. Color and other parameters could be “dialed in” in manual versions and remotely-controlled in others.

Elements can be provided or driven with various known encoding, sensing, and/or indexing schemes, analog or digital, for determining element position/orientation. Indexing and/or encoding marks can be produced or applied with or in addition to the pattern of light-modifying material(s) on the light-modifying element.

Because of the close, parallel, co-axial relationship of the light-modifying elements and their rotation (typically) about a common central axis (whether on a center post or not) the position of a plurality of such elements can be determined by a shared means. For example, a directional light source (e.g., an LED or low-power laser diode) can be aimed parallel to the axis of rotation of a plurality of elements, each of which is provided with one or more indexing features (such as a projection or mark) of limited extent. At initial power-up the orientation of the various elements will, likely, leave the path between the directional light source and a detector unobstructed. If the path should be obstructed, the system can rotate all the elements until an unobstructed condition is reached. Once an unobstructed path is reached (initially or by rotation) the system can sequentially rotate each element in turn, until its indexing feature is “found” by obstructing the path to the detector. The orientation of that element having been determined, it is rotated clear of the path and succeeding elements rotated until their indexing features have been “found” in turn. With the orientation of the various elements now determined, known techniques (e.g., actuator “pulse-counting”) can be used in subsequent actuation. Further, the occlusion of the path between source and detector (the former, in certain applications, being derived from the primary light source) during normal operation can be predicted and actual occlusions compared with prediction to assure continued (and, when necessary, to correct) calibration.

Light-modifying elements can be used whose substrate has been formed or selectively removed for completely open passages where light-modifying material is not required, with the benefit of increased transmission and/or other advantages. Such light-modifying elements can, for example, be cast, stamped, or otherwise produced from materials with integral light-modifying effect.

While the embodiments illustrated have employed generally planar light-modifying elements, the invention (and its advantages) need hardly be restricted to such embodiments.

For example, one or more of the optical and/or the light-modifying elements might have a part-spherical (or otherwise curved) or conic, rather than a planar, form.

Plural such systems can be used with a single light source; with multiple light sources; or a single such system with plural light sources.

In one application, the known “strip-light”, a plurality of generally circular light source/reflectors (such as MR-16 or PAR-38 or R-40 lamps) are arranged in a line in a common fixture. A plurality of such sources can be provided with light-modifying and other elements, and can be coordinated in operation by means including a mechanical connection between those elements associated with a plurality of such sources. For example, one or more belt can be used to drive the elements associated with a plurality of such sources. Or such elements can be provided with a mechanical linkage (including tie-rods or geared rims that intermesh) so that the rotation of one element (by manual or powered means) rotates the elements associated with a plurality of sources. Intermeshing gears of two elements will normally tend to reverse rotational directions (without an intermediate gear or other means) but the pattern of the luminous form and light-modifying material can also be reversed from source to source to correct for a reversed direction of rotation.

Multiple sources, each with a parameter-modifying system can be combined (or “bundled”) in other arrangements, with parallel or non-parallel outputs

A single source and light-collector can also be used with a plurality of parameter-modifying systems of smaller size. With or without mechanical coupling, the plurality of smaller parameter-modifying systems can be disposed before a common light-collector. Various techniques can be used to reduce light losses in the regions defined between them.

A common parameter-modifying system can also be used with a plurality of light sources and/or light collectors. In one example, a relatively large parameter-modifying system can be disposed in front of a plurality of light-collectors, each with a light source. In one embodiment, each such light-collector can be in the form of one pie-wedge-shaped segment, the plurality of assembled light-collectors substantially filling the form of the larger parameter-modifying system.

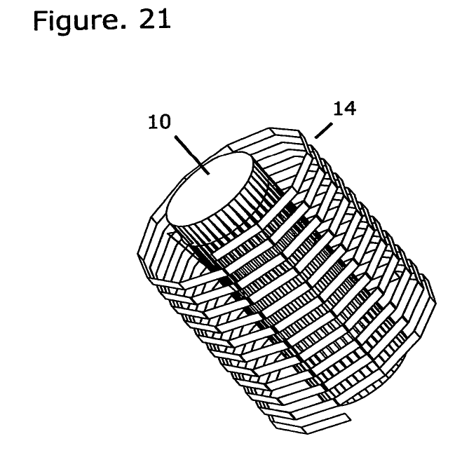

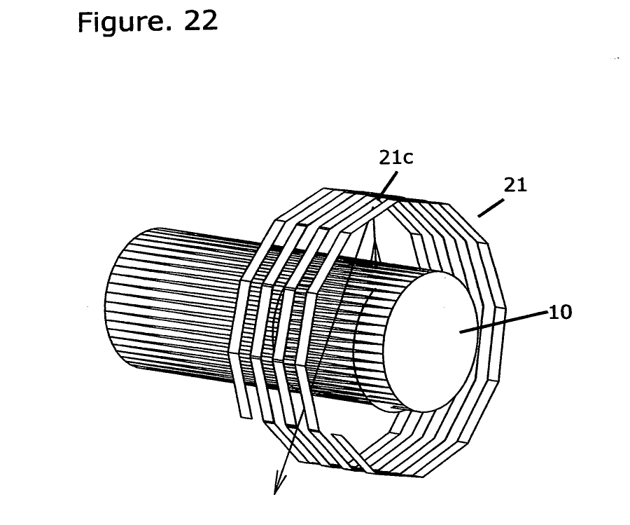

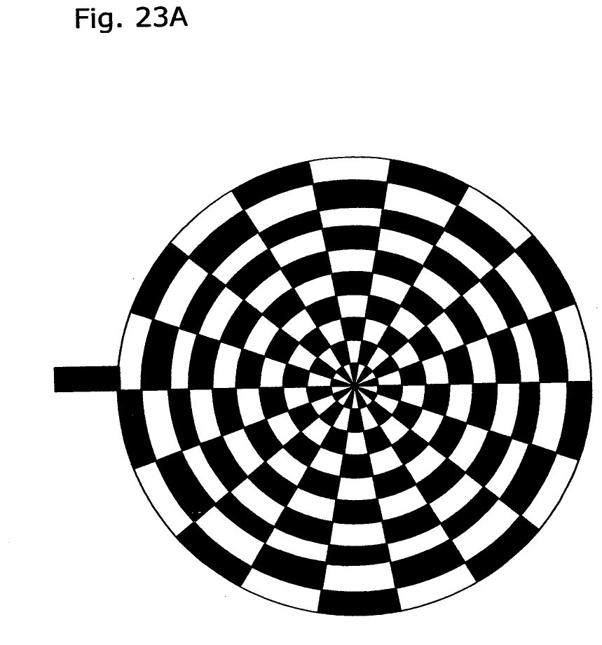

FIGS. 20 and 21 illustrate one of many embodiments in which at least one light-modifying element is formed into a generally cylindrical shape, and surrounds a light source, which, itself, can be generally tubular (such as a flourescent tube or an incandescent lamp having a linear filament).

In one such embodiment, the pattern of light-modifying material 14 is generally helical (“screw thread-like”).

By the use of a mask or other means, whether integral with; applied to; or surrounding light source 10, a similarly helical luminous form can be created, into which the light-modifying material 14 can be progressively inserted, either by rotation about and/or displacement along its elongated axis.

Like the systems previously disclosed, the efficiency of the system can be improved by many means.

In one example, a layer or layers of optical material can be applied to or spaced near or away from the cylindrical light source, that collects the luminous output of the source and directs it into the desired helical (or other) luminous form by “bending” it around the preferably non-luminous areas of the luminous form.

In another example, illustrated in FIG. 21, a mask 21 can be spaced away from the surface of the light source 10 and the inner (source-side) face of the opaque areas of the mask 21c can be provided with a surface, coating, or material that reflects or redirects light incident upon it.

The light-modifying material may also be in a series of cylindrical “rings”, having edges defining a plane substantially perpendicular to the elongated centerline, rather than a helical form. Alternatively, “rings” can be “cut on a bias”.

Other patterns are possible.

The scale of such patterns can be adjusted to the needs and economics of the application and the fabrication process.

In some embodiments, the system can be used to provide for progressive insertion of material changing color, intensity, diffusion, and/or other parameters. The necessary components are very economical to produce and can be employed with present lamps and in most present fixtures. Adjustment can be manual or by remote actuator, and, in the former case, indexing/calibration marks and/or other features can be provided to indicate the degree of offset between the mask or luminous form and the modifier, so that the same effect can be readily reproduced at different times and/or in different fixtures.

Where a substantial relative distance exists between the light source and the element(s) “end caps” can be employed to capture light that might otherwise pass outside the ends of the cylindrical form.

It will be understood that the generally cylindrical form can be used with a shorter light source—or with a point source—and, for example, around an axially-mounted light source contained within a larger reflector (such as a parabaloid, an ellipsoid, or other form) that is creating a directional beam.

Geometries are possible in which the mask, optical elements, and/or light-modifying elements have surfaces following a generally spherical or other form around a source.

Where the prior embodiments illustrate light-modifying material in patterns coincident with a generally planar, cylindrical, spherical, or other shape generally perpendicular to the ray paths, variations are possible in which light-modifying material is formed in shapes that are normally at an acute angle to that centerline. For example, a long “strip” of light-modifying material may be wound into a spiral form, with its width parallel to center axis around which it is wound (resembling a clock mainspring). With this shape aligned with its central axis generally parallel with that of a light beam, such material would have little effect (being “on edge” to the beam and therefore intersecting few rays in it) and none at all if a complementary spiral luminous form were used. When, however, the coil of material “tilted” with respect to the beam (their central axes made non-parallel), the filter material would be inserted in increasing proportion into the beam.

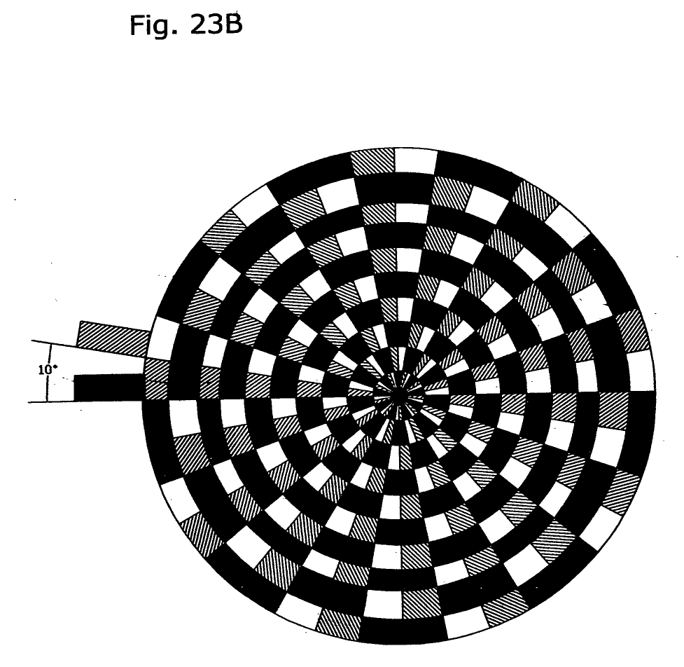

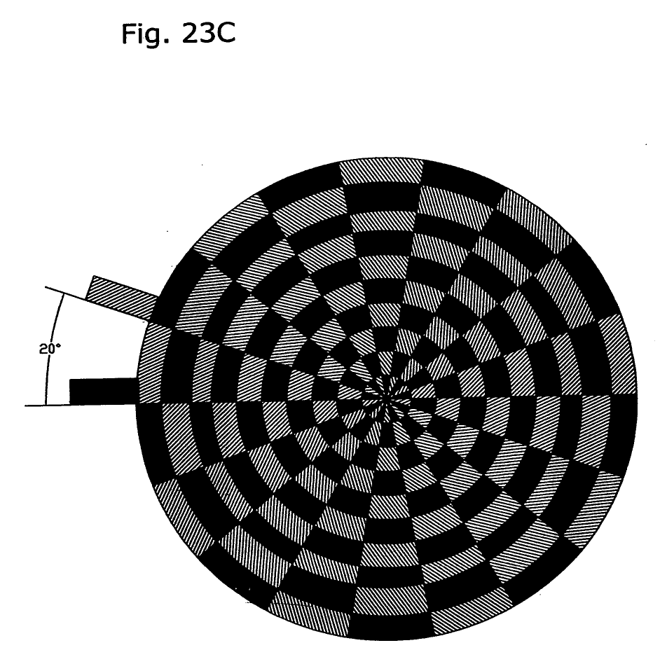

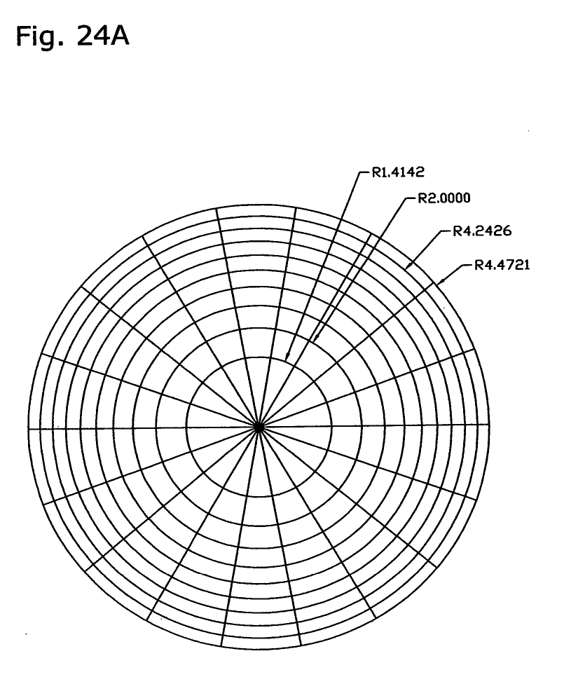

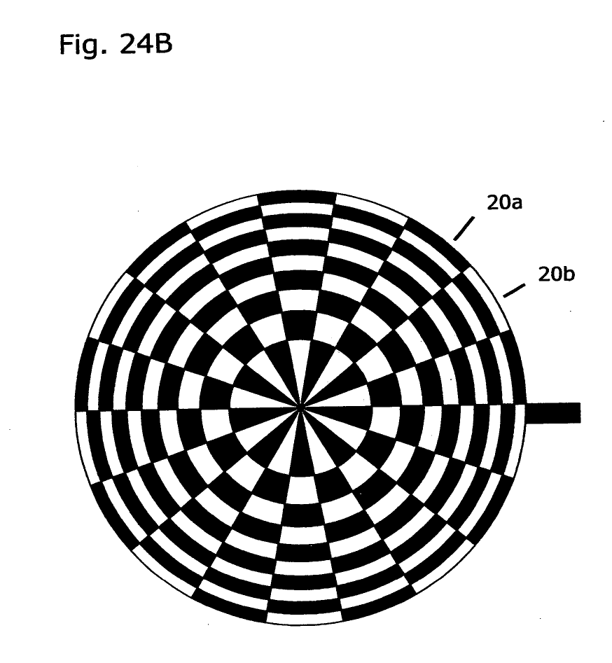

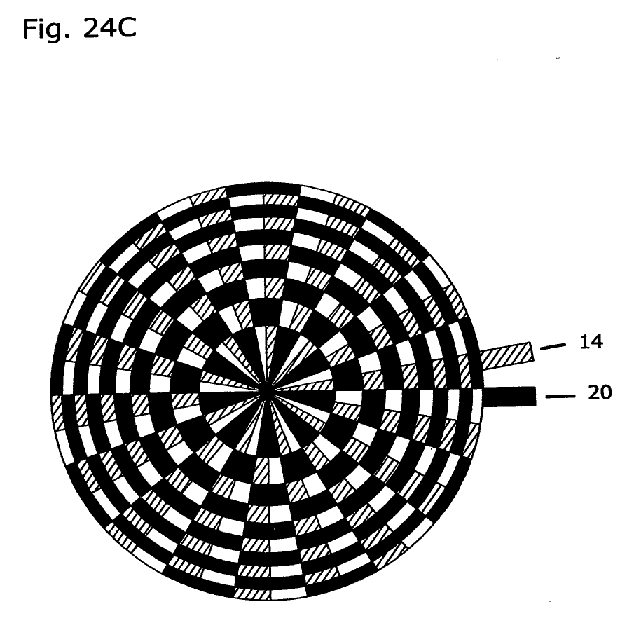

FIGS. 23A-24B illustrate another system, in which the luminous form can be a series of arcuate segments of a plurality of concentric rings. In the simplest “mask” version, each such ring is divided into an even number of equal segments. Light-modifying elements are employed having a similar pattern, and their rotation (and/or other displacement) relative to the mask extends and retracts their light-modifying material in and out of the luminous form that passes through the mask. It will be seen that the required rotation for full-range adjustment is directly proportional to the number of segments into which the concentric rings are divided—from 180 degrees to a few degrees. System efficiency be improved by any means, including those previously described, including by re-directing light that would otherwise be obstructed. For that purpose, the segments of adjacent concentric rings through which light passes can be alternated radially, such that simple radial displacement of the light rays otherwise obstructed can be employed.

FIG. 23A is an elevation, perpendicular to the optical path, illustrating one embodiment of such another system employing concentric rings with alternating application of light-modifying material in 20 degree segments.

FIG. 23B is an elevation, perpendicular to the optical path, illustrating one embodiment of such another system employing concentric rings with alternating application of light-modifying material, wherein the light-modifying element is rotated 10 degrees, resulting in partial effect.

FIG. 23C is an elevation, perpendicular to the optical path, illustrating one embodiment of such another system employing concentric rings with alternating application of light-modifying material, wherein the light-modifying element is rotated 20 degrees, resulting in full occlusion.

FIG. 24A is an elevation, perpendicular to the optical path, illustrating one embodiment of such another system, employing concentric rings with alternating application of light-modifying material, where the alternating concentric ring pattern period is a function of radial distance, such that the area of each segment is equal.

FIG. 24B is an elevation, perpendicular to the optical path, illustrating one embodiment of such another system employing concentric rings with alternating application of light-modifying material, where the alternating concentric ring pattern period is a function of radial distance, such that the area of each segment 20a, 20b throughout is equal. When applied to an evenly illuminated field, the radiant intensity of each segment is equal.

FIG. 24C is an elevation, perpendicular to the optical path, illustrating one embodiment of such another system employing concentric rings with alternating application of light-modifying material as described in FIG. 24B, where the light-modifying element is rotated 10 degrees relative to the mask 20.

Other variations are possible and should not be understood as limited except by the claims.

It will be understood that many of the techniques disclosed in the context of this application may be employed with other color-changing, color-mixing, and/or parameter-modification systems and in other applications.

What is claimed is:

1. An apparatus for varying at least one parameter of a light beam, said light beam having a source,
said apparatus being suitable to be disposed in said light beam, said disposition of said apparatus in said light beam defining a prior portion of said light beam between said apparatus and said source, and a subsequent portion of said light beam beyond said apparatus,
at least one light modifying element having light modifying material in a pattern, said pattern including areas having said light-modifying material and other areas without said light-modifying material,
at least one additional element, said additional element altering the transmission of light in said beam such that the displacement of said light modifying element relative to said additional element varies the relative effect of said light modifying material on said light beam beyond said apparatus, and,
at least a portion of said other areas of said light modifying element being completely open.

2. An apparatus for varying at least one parameter of a light beam, said light beam having a source,
said apparatus being suitable to be disposed in said light beam, said disposition of said apparatus in said light beam defining a prior portion of said light beam between said apparatus and said source, and a subsequent portion of said light beam beyond said apparatus,
at least one light modifying element having light modifying material in a pattern, said pattern including areas having said light-modifying material and other areas without said light-modifying material,
at least one additional element, said additional element altering the transmission of light in said beam such that the rotation of said light modifying element relative to said additional element varies the relative effect of said light modifying material on said light beam beyond said apparatus, and,
said light modifying element being rotated about a central hub.

3. An apparatus for varying at least one parameter of the luminous energy produced by a light source, said source being substantially linear and having an elongated central axis,
at least one light modifying element at least a portion of a generally cylindrical form, generally coaxial with said elongated central axis of said light source, said light modifying element having light modifying material in a pattern, said pattern including areas having said light-modifying material and other areas without said light-modifying material,
at least one additional element, said additional element at least a portion of a generally cylindrical form, generally coaxial with said at least one light modifying element, and altering the transmission of light in said beam such that the displacement of said at least one light modifying element relative to said at least one additional element varies the relative effect of said light modifying material on said light beam beyond said apparatus.
